(19) United States
(12) Patent Application Publication
(10) Pub. No.: US 2014/0110429 A1
(43) Pub. Date: Apr. 24, 2014

(54) Apparatus for Dispensing Fuel

(71) Applicants: Yury Tronik, Serpukhov (RU); Peter Mouler, Irvine, CA (US); Andrei Kaloshin, Moscow (RU)

(72) Inventors: Yury Tronik, Serpukhov (RU); Peter Mouler, Irvine, CA (US); Andrei Kaloshin, Moscow (RU)

(73) Assignee: Argosy Technologies, Palm Desert, CA (US)

(21) Appl. No.: 13/659,270

(22) Filed: Oct. 24, 2012

(51) Int. Cl. B67D 7/04

(52) U.S. Cl. 222/23; 222/54

(57) ABSTRACT

A fuel dispensing apparatus has an electronic counting unit; a hydraulic device including a filter, a mass flow meter, a valve for changing a flow provided with an electromagnetic control, a pumping hose, a gas indicator, a dispensing faucet, and an electrically-operated pump; and a fuel reservoir, with the electrically-operated pump arranged in the fuel reservoir immersed in fuel and connected by a pipeline through the filter with the mass flow meter having an outlet connected with the valve for changing a flow rate with the electromagnetic control, an outlet of the valve is connected with the pumping hose, the gas indicator, and the dispensing faucet, and a temperature sensor which determines a temperature of fuel and provide information for dispensing an accurate does requested by a user regardless of fluctuations of the fuel temperature.

### BACKGROUND OF THE INVENTION

The present invention relates to apparatus for dispensing fuel, for example for pumping fuel into vehicles and it can be used for dispensing vehicle fuel on vehicle fuel dispensing stations.

Fuel dispensing apparatuses for this purpose are known in the art. RU 45120 discloses a fuel dispensing apparatus with an electric motor, a pump, a filter, a volume measuring unit, a valve system, a counting device, a gas indicator, a dispensing faucet, a pumping hose, in which the electric motor, the pump, the filter, the volume measuring unit, the mechanical counting device, and the indicator are confined in a single housing, the mechanical counting device incorporates a pulse sensor and an indicator of a summary fuel count, the electric motor is connected with the pump by a belt transmission, and the volume measuring unit is connected mechanically with the counting device.

A fuel dispensing apparatus disclosed in RU 20756 has a filter, a pump, an electric motor, a gas separating unit, a float chamber, a hydraulic type flow rate measuring unit, a valve for flow rate reduction with an electromagnetic control, a pumping hose, an indicator, a dispensing faucet.

RU 45120 discloses a fuel dispensing apparatus with a filter, an electric motor, a gas separating unit, a float chamber, a volume measuring unit, a flow rate change measuring valve with an electromagnetic control, a pumping hose, an indicator, an indicator, and a dispensing faucet.

The above mentioned fuel dispensing apparatuses do not have a high accuracy of fuel dispensing and are characterized by a complicated construction.

A further fuel dispensing apparatus is disclosed in RU 82454 and includes a filter, an electric motor, a pump, a gas separating unit, a float chamber, a mass flow meter, a flow rate valve with an electromagnetic control, a pumping hose, an indicator, and a dispensing faucet.

This apparatus also has a complicated construction and insufficient reliability at high temperatures of environment.

### SUMMARY OF THE INVENTION

Accordingly it is an object of the present invention to provide a fuel dispensing apparatus, which eliminates the disadvantages of the prior art and is a further improvement.

In keeping with these objects and with others which will become apparent herein after, one feature of the present invention resides, briefly stated in a fuel dispensing apparatus which has an electronic counting unit; a hydraulic device including a filter, a mass flow meter, a valve for changing a flow provided with an electromagnetic control, a pumping hose, a gas indicator, a dispensing faucet, and an electrically-operated pump; a fuel reservoir, with the electrically-operated pump arranged in the fuel reservoir immersed in fuel and connected by a pipeline through the filter with the mass flow meter having an outlet connected with the valve for changing a flow rate with the electromagnetic control, while an outlet of the valve is connected with the pumping hose, the gas indicator, and the dispensing faucet; and a temperature sensor which determines a temperature of fuel and provides an accurate dose of a dispensed fuel with consideration of the determined fuel temperature.

In accordance with another feature of the present invention, the temperature sensor is connected with the counting unit, and the counting unit, based on the information about the temperature of the fuel received from the temperature sensor, provides corresponding corrections to ensure that the apparatus dispenses exactly the dose of fuel requested by a user regardless of the temperature fluctuations.

The temperature sensor, in accordance with a further feature of the present invention, can be located in a fuel line between the filter and the mass flow meter.

In accordance with another feature of the present invention, in the fuel dispensing apparatus the mass flow meter of the hydraulic device and the electronic counting unit are connected with one another via an interface.

Still another feature of the present invention is that in fuel dispensing the mass flow meter is a Coriolis-type flow meter which determines a mass flow based on a time difference of signals of input and output detectors on mass flow guiding pipes, caused by Coriolis force.

In accordance with another feature of the present invention, in the inventive fuel dispensing apparatus the electronic counting unit is configured to control the fuel dispensing apparatus during dispensing a dose of fuel and also to exhibit information about a dispensed quantity of fuel.

In the fuel dispensing apparatus of the invention the valve can be configured to adjust a flow rate during a process of dispensing a dose of fuel in different phases of the fuel dispensing process.

Furthermore in the inventive fuel dispensing apparatus the interface connecting the mass flow meter of the hydraulic device with the electronic counting unit can be configured to provide an information exchange between the mass flow meter and the electronic counting device about a quantity of fuel from a beginning of a process of dispensing a dose of fuel.

The novel features of the present invention will be set forth in particular in the appended claims. The invention itself however both as to its construction and its manner of operation, will be best understood from the following description of the preferred embodiments, which is accompanied by the following drawings.

### BRIEF DESCRIPTION OF THE DRAWINGS

FIG. 1 of the drawings is a view showing an apparatus for dispensing oil products or fuel in accordance with the present invention

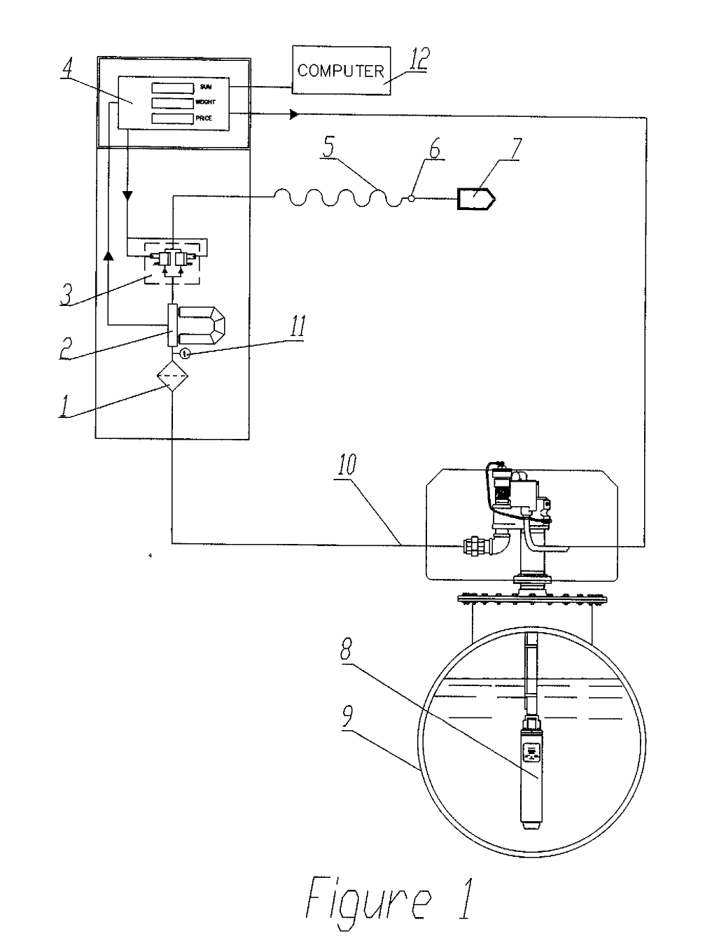

### DESCRIPTION OF THE PREFERRED EMBODIMENTS

A fuel dispensing apparatus in accordance with the present invention has a filter 1, a mass flow meter 2, a mass flow changing valve with an electromagnetic control 3, a counting device 4, a pumping hose 5, a gas indicator 6, a dispensing faucet 7, an electrically controlled pump 8 located in a reservoir 9, connected by a pipeline 10 with the apparatus, a sensor of temperature of fuel or oil product 11, and a computer 12.

The mass flow meter 2 is used to measure a quantity of a flowing oil products or fuel. It can be formed as a mass flow meter of Coriolis type Micro Motion model F produced by “Emerson Process Management. Micro motion Inc.”. The mass flow meter has a sensor which measures a mass flow, a density of fluid, a temperature of sensor pipes, and a convertor which converts the sensor information into output signals. During movement of the fluid through the sensor through the sensor pipe Coriolis forces are generated, detectors measure a phase shift during the movement of opposite sides of the sensor pipe, and the mass flow rate is determined as proportional to a time difference between the signals.

The mass flow changing valve with electromagnetic control 3 regulates a mass flow rate of the fuel in the process of dispensing a dose. It has two hydraulic channels of different cross sections, each controlled by an electromagnetic coil and both closed when the fuel is not dispensed. In the beginning of dose dispensing the channels are opened in response to command from the counting unit, and the apparatus dispenses the fuel with a full flow rate. At the point of 0.5-1.0 l before the end of the dose the counting unit turns of the channel with a larger cross section and a flow rate significantly reduces, in order to obtain an accurate determination of the dose. At the moment of finishing of the dose the counting unit turns off the channel with a smaller cross section and stops dispensing the fuel.

The counting device 4 is an electronic microprocessing device for exhibiting information about the dispensed quantity of fuel and controlling the apparatus during dispensing of dose of the fuel.

The temperature sensor 11 is a sensor which senses the temperature of the fuel or oil product which is dispensed by the apparatus for dispensing fuel in accordance with the present invention. The temperature sensor 11 can be located for example on a fuel line between the filter and the mass flow meter. It is used to measure the temperature of fuel so that it will be taken into consideration during the process of dispensing the fuel, to dispense a dose of fuel requested by a user, regardless of temperature fluctuations.

The fuel dispensing apparatus in accordance with the invention operates in the following manner.

A fuel dispensing station has a system for controlling fuel dispensing apparatuses, which includes the computer 12 with a program software for remote control. An operator introduces into the computer the data about a quantity of fuel paid by a user, for example a vehicle driver, and a particular number of an apparatus which will be dispensing the fuel. The program software of the computer 12 sends these data to the electronic counting unit 4 via interface. When the dispensing faucet 7 is taken from the apparatus, the counting unit 4 brings the numbers on the indicators to zero and turns on the electrically controlled 8 and the flow rate changing valve with electromagnetic control 3.

The fuel pumped by the pump 8 is supplied through the pipeline 10 to the filter 1, which cleans the fuel from mechanical impurities. Then the fuel is supplied through the line on which the temperature sensor 11 is arranged, to the mass flow meter 2, which measures a mass of the moving fuel and accumulates the obtained data in the memory of the mass flow meter 3. Then the fuel is supplied through the open valve 3 into the pumping hose 5, the gas indicator 6 and the dispensing faucet 7.

The mass flow meter 2 includes a microprocessing converter, which accumulates the data about the measured quantity of liquid fuel in volume and mass units. The mass flow meter 2 and the counting unit 4 are connected by interface, via which the counting unit 4 inquires the data from the converter after the last dispensing step. In accordance with the given quantity obtained from the computer 12, the counting device calculates a value, with which the fuel dispensing apparatus must stop the dispensing process.

At the end of the dispensing dose, in response to a command from the counting unit 4, a large cross section channel of the valve 3 is turned off and a fuel supply diminishes. At the end of the fuel dispensing process a small cross section channel of the valve 3 is turned off, and the operation of the fuel dispensing apparatus stop so that the exactly inquired dose is dispensed. Indicators of the counting unit 4 exhibit the information about the dispensed quantity of fuel.

When the fuel dispensing apparatus operates to take into consideration the fuel temperature or to adjust a fuel dose to a standard temperature, the counting unit 4 receives the information from the temperature sensor 11 and corrects a value of the dose to be dispensed. If the temperature of fuel differs from the standard temperature and as a result the fuel expands or contacts, the counting device which obtained the information about the fuel temperature, calculates the dose to be dispensed, so that it corresponds to the fuel quantity requested by a user. The counting device 4, in correspondence with this, turns of the flow rate changing valve in a particular moment to provide dispensing of the proper dose.

The invention is not limited to the details shown since various modifications and structural changes are possible without departing from the spirit of the present invention.

What is desired to be protected by Letters Patent is set forth in particular in the appended claims.

1. A fuel dispensing apparatus; comprising:
an electronic counting unit; a hydraulic device including a filter, a mass flow meter, a valve for changing a flow provided with an electromagnetic control, a pumping hose, a gas indicator, a dispensing faucet, and an electronically-operated pump; and a fuel reservoir, wherein said electronically-operated pump is arranged in said fuel reservoir immersed in fuel and connected by a pipeline directly to the filter and through said filter with said mass flow meter located immediately downstream of said filter and having an outlet connected with said valve for changing a flow rate with said electromagnetic control, while an outlet of said valve is connected with said pumping hose, said gas indicator, and said dispensing faucet; and a temperature sensor which determines a temperature of fuel and provides an accurate dose of a dispensed fuel with consideration of the determined fuel temperature, wherein said temperature sensor is arranged on a fuel line between said filter and said mass flow meter and determines a temperature of fuel in said fuel line, and no additional components are located between said filter and said temperature sensor, and also no additional components are located between said temperature sensor and flow meter.

2. A fuel dispensing apparatus as defined in claim 1, wherein said temperature sensor is connected with said counting unit and sends to the latter information about the fuel temperature determined by said temperature sensor, and said counting unit, based on the information about the fuel temperature received by the sensor, provides corrections to ensure that the apparatus dispenses exactly a dose of fuel requested by a user, regardless of fluctuations of fuel temperature.

3. (canceled)

4. A fuel dispensing apparatus as defined in claim 1, wherein said mass flow meter of said hydraulic device and said electronic counting unit are connected with one another via interface.

5. A fuel dispensing apparatus as defined in claim 1, wherein said mass flow meter is a Coriolis-type flow meter which determines a mass flow based on a time difference of signals of input and output detectors on mass flow guiding pipes, caused by Coriolis force.

6. A fuel dispensing apparatus as defined in claim 1, wherein said electronic counting unit is configured to control the fuel dispensing apparatus during dispensing a dose of fuel and also to exhibit information about a dispensed quantity of fuel.

7. A fuel dispensing apparatus as defined in claim 1, wherein said valve is configured to adjust a flow rate during a process of dispensing a dose of fuel in different phases of the fuel dispensing.

8. A fuel dispensing apparatus as defined in claim 4, wherein the interface connecting said mass flow meter of said hydraulic device with said electronic counting unit is configured to provide information exchange between said mass flow meter and said electronic counting device about a quantity of fuel from a beginning of a process of dispensing a dose of fuel.

9-11. (canceled)
